(19) United States
(12) Patent Application Publication
(10) Pub. No.: US 2004/0080942 A1
(43) Pub. Date: Apr. 29, 2004

(54) Unit is bottle cap receptacle with sound activated lights and a free standing obstacle bar

(76) Inventor: Warren Millet, Ridgeland, MS (US)

Correspondence Address: WARREN MILLET, 595 Bryceland Boulevard, Ridgeland, MS, 39157, US

(21) Appl. No.: 10/279,497

(22) Filed: Oct. 24, 2002

(51) Int. Cl. F21V 33/00

(52) U.S. Cl. 362/253

(57) ABSTRACT

My new invention has a much better function than previously invented bottle cap receptacles. The bottle cap receptacles before this invention in my opinion were poorly designed because I have used the previously invented units before.

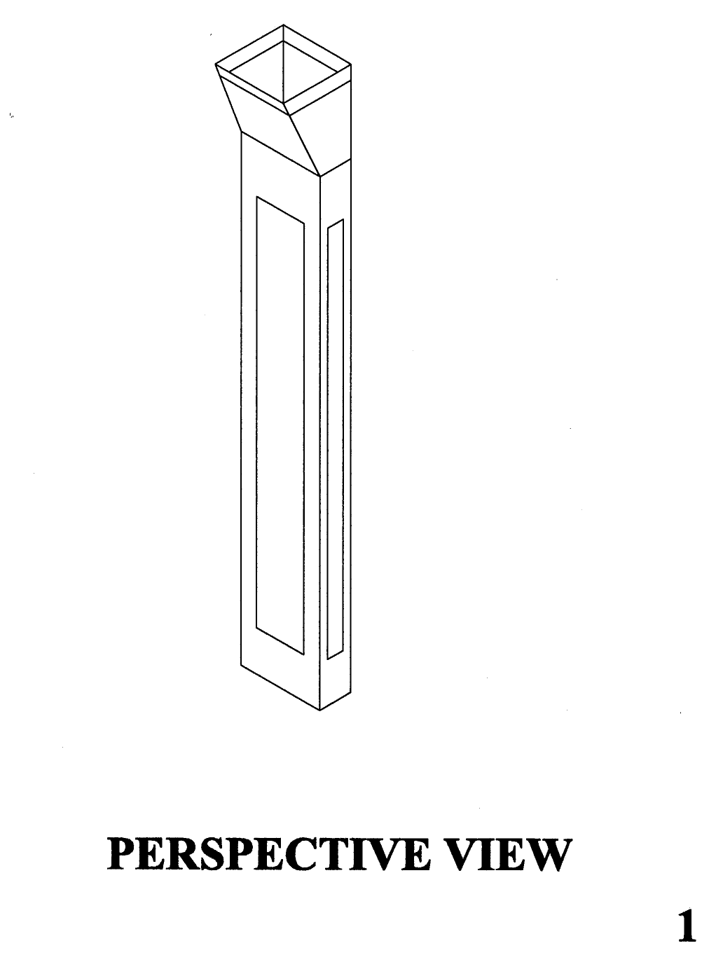

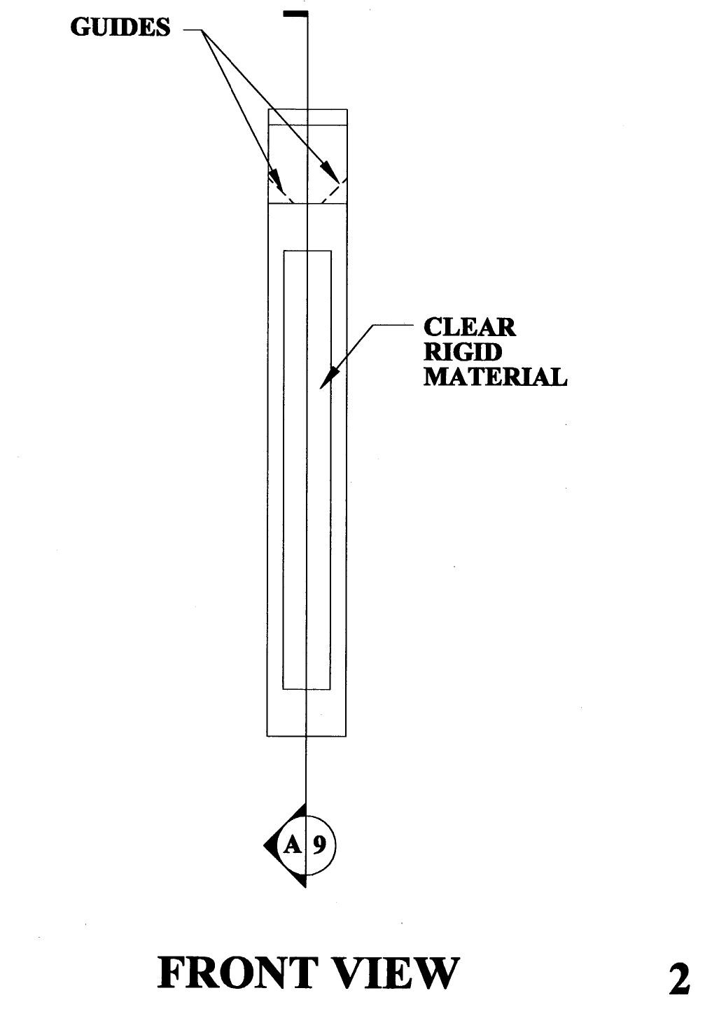

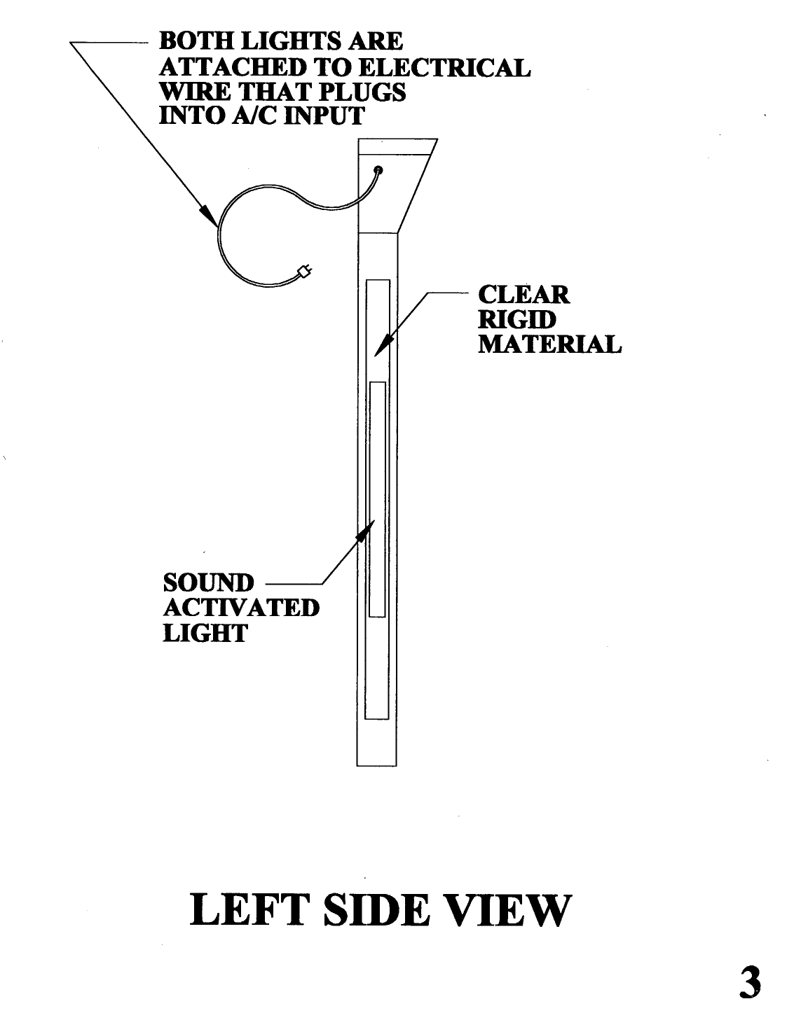

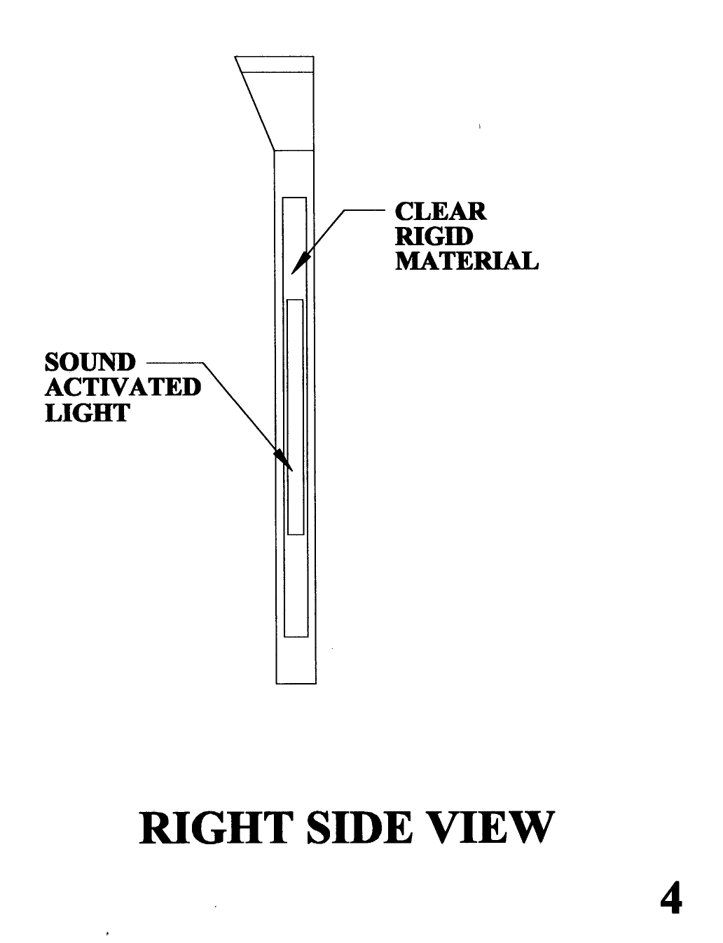

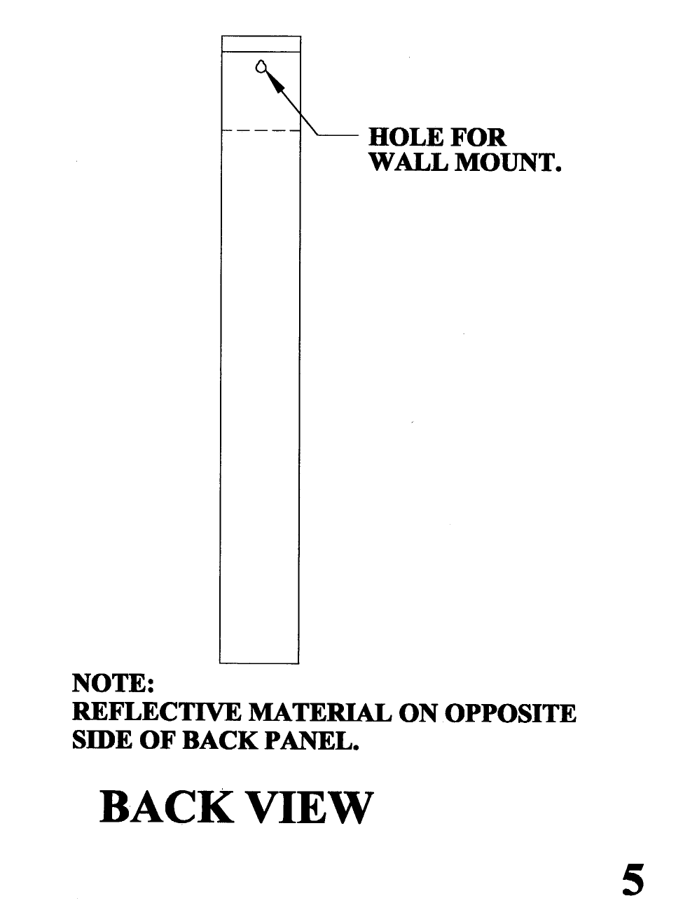

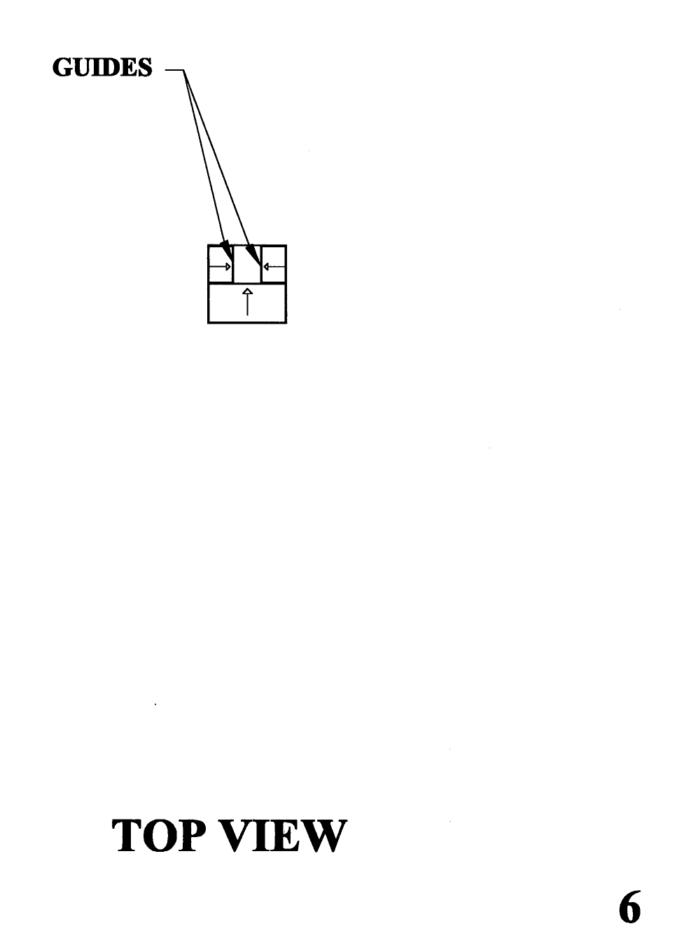

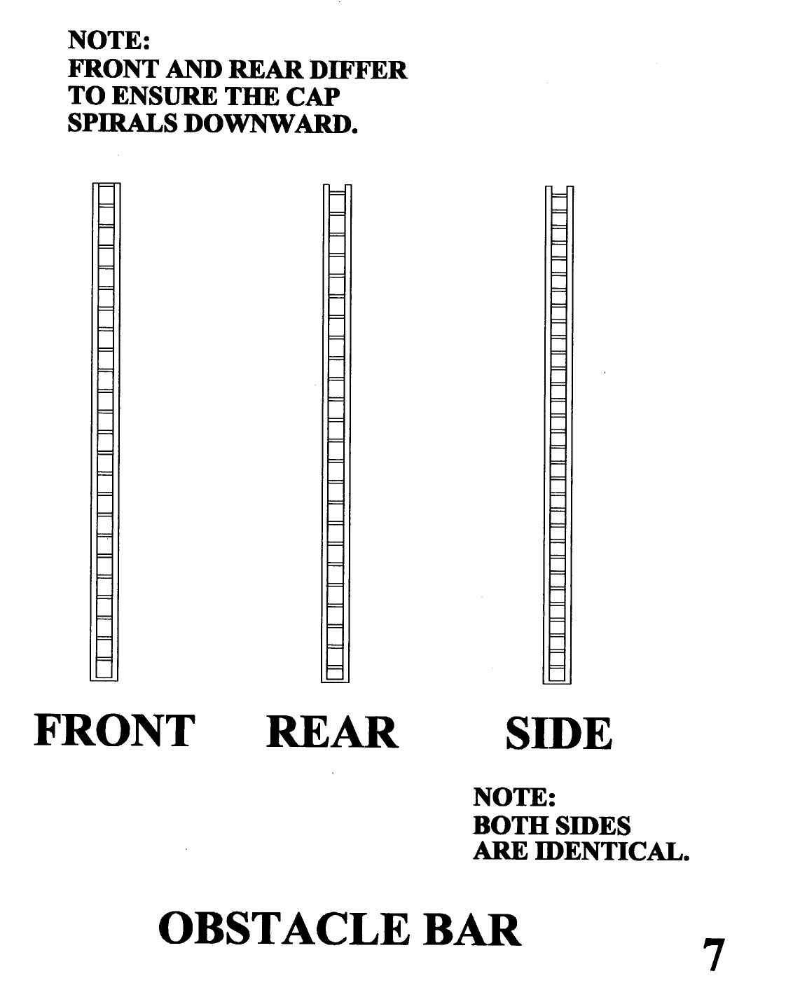

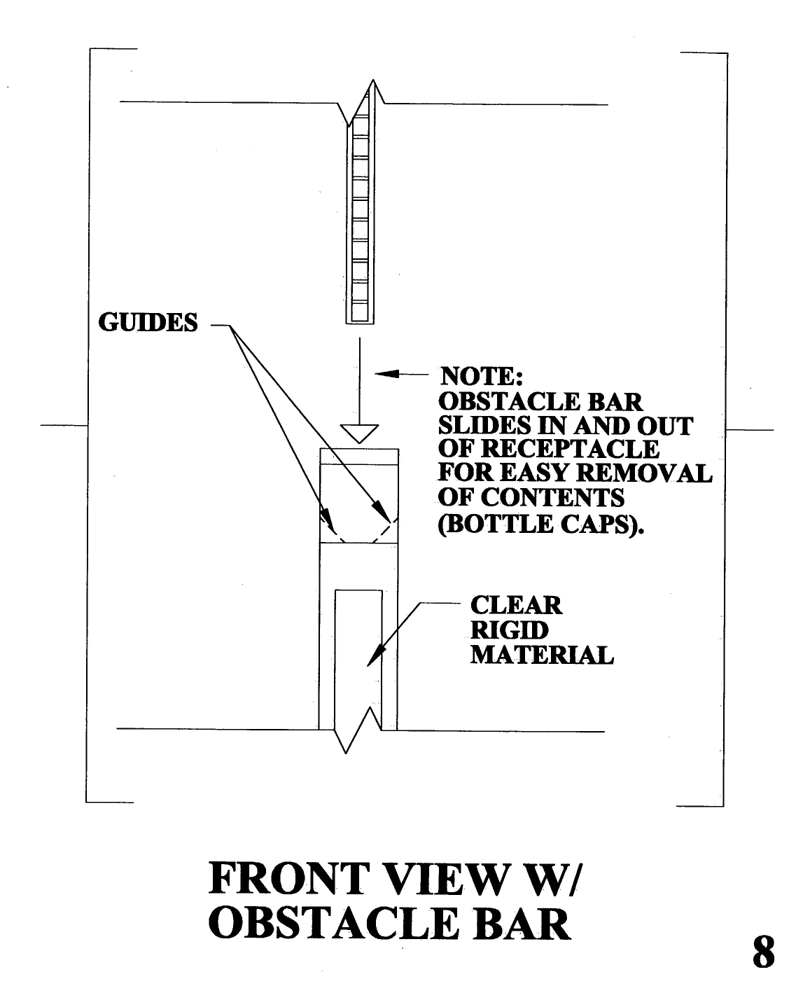

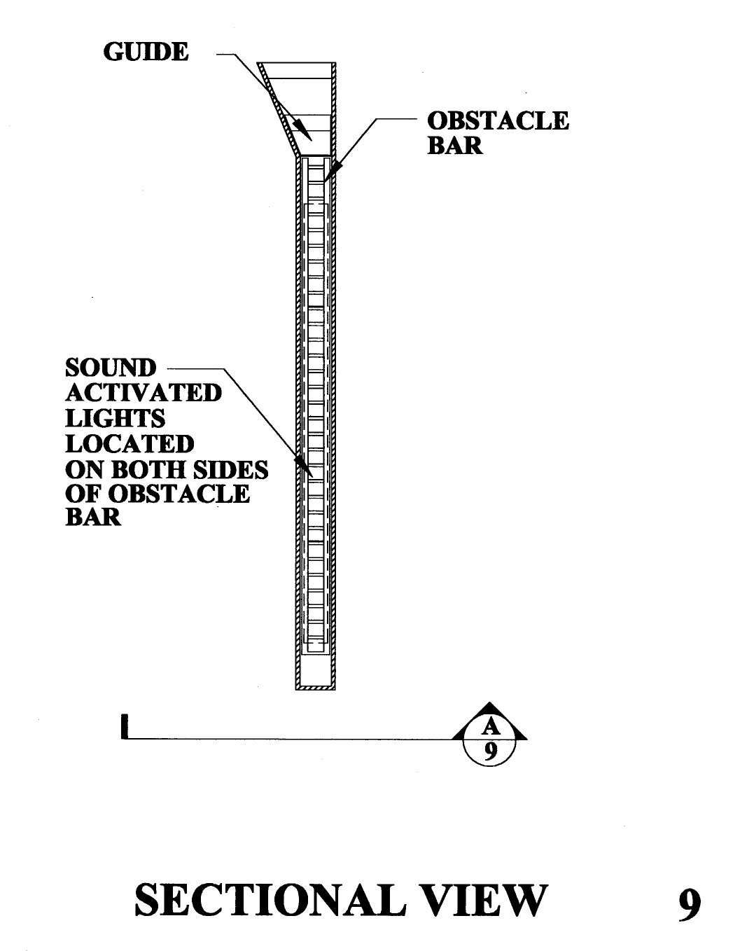

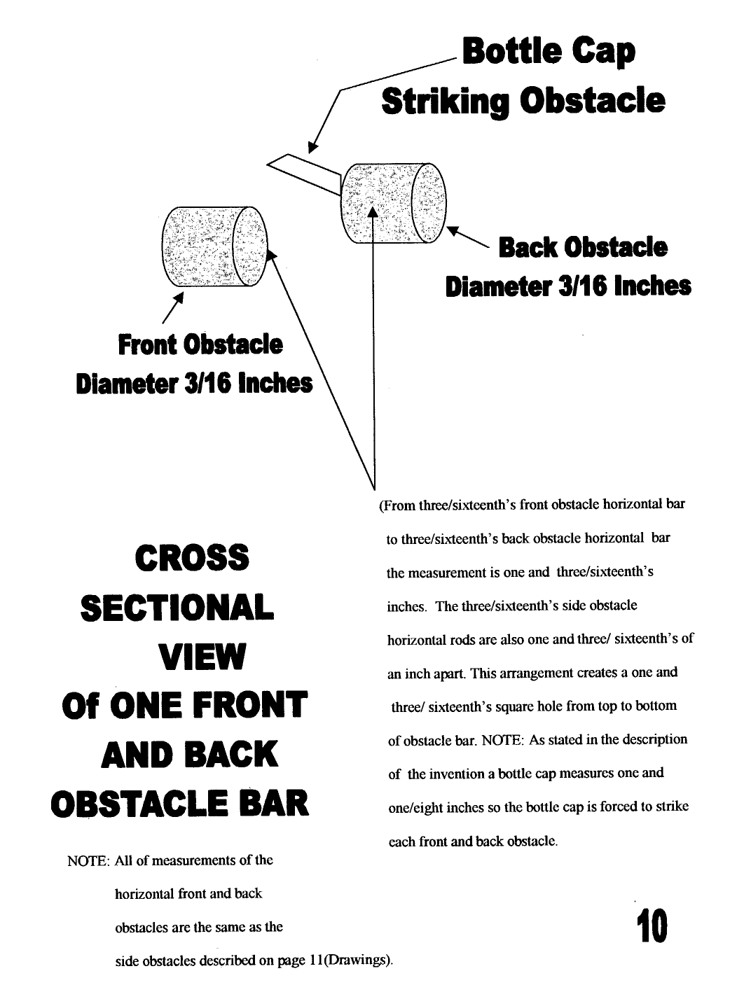

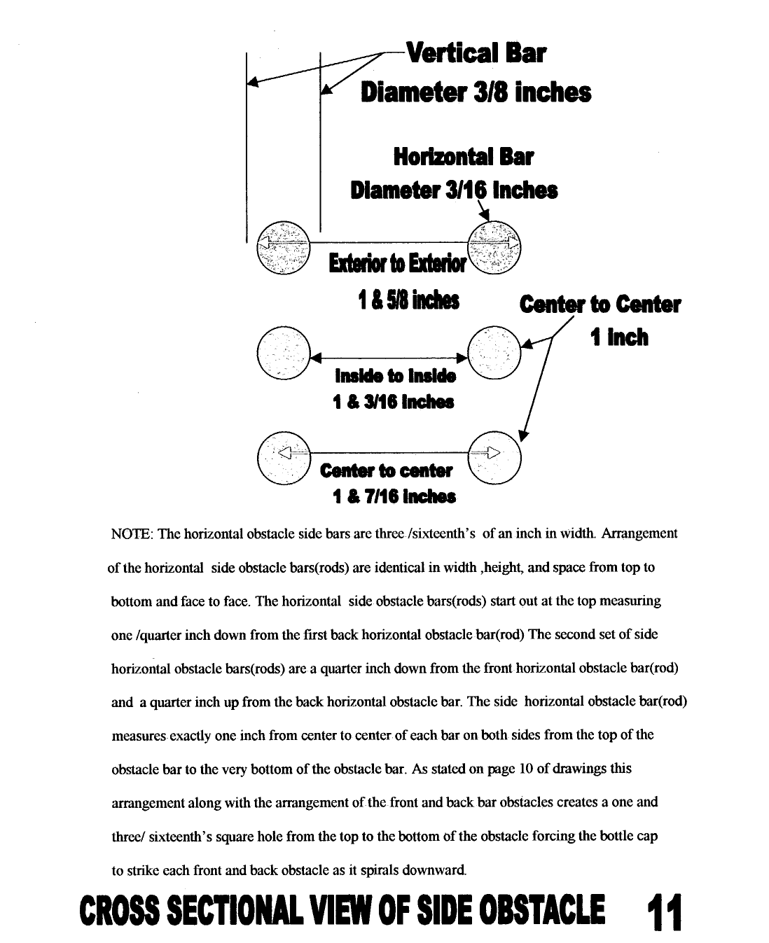

Many times in using the units that were built before the bottle cap would fall on the floor instead of descending to the bottom of the unit.

The way that my invention is designed the bottle cap always goes into the mouth of the unit and bottle cap always descends into the unit.

The obstacle bars are designed to allow the bottle cap to strike each and every obstacle descending down the unit. I have tested the unit and each and every time the bottle cap strikes each bar as it decends down the unit.

The decision as to when to empty the obstacle bar is up to the person utilizing the unit. The fact that the obstacle bar is a separate part of the unit makes it easy for the person to empty the contents(bottle caps).

A person can enjoy watching the bottle cap as it descends through the reflection of the reflective material attached to the back of the unit.

Any sound activated light could be used in this application. In the manner that the unit is constructed the concept is new to the previously invented units.

### BACKGROUND OF THE INVENTION

My invention started out around the beginning of July 2002. My reason for making the invention was kind of a mistake in a way. I have had a couple of room mates that enjoyed drinking bottled beer. My problem was I only had a very small unit that did not hold many bottle caps. So, I kept having to empty that unit every couple of days. I then went to a workshop where I began to build a bigger unit.

After that unit was built it served the purpose but I thought to myself that I might turn this unit into something a little more exciting. At first, I did not know what I was going to do so every day I would come up with something new.

The obstacle bar was the first because I wanted it to sound exciting as the bottle cap fell to the bottom of the unit. I had to play around with the obstacle bar until my measurements were correct. I then stopped working on the unit for a while(I would say about a week or so).

Then one day I saw these lights that were pretty neat looking. I asked a guy that had them what the lights function were and he told me that he used them to plug into his car and they would flash to the music playing on his car stereo. That is when the wheels started really turning in my head to put these lights to a different use. So, I installed a pair that I purchased into the unit that I constructed Wow! It really looked exciting! I then installed a reflective material on the back inside of the unit so if a person looked at the bottle cap as it would descend it looked like two bottle caps falling creating a reflection of itself.

I installed some small guides on the inside on each side to guide the bottle caps into the obstacle bar. This sums up the background of the invention.

### BRIEF SUMMARY OF THE INVENTION

### THE BOTTLE OPENER'S FUNCTION (THIS IS NOT PART OF THE INVENTION BUT IS A NECESSARY ITEM FOR OPERATION)

It is a permanent fixture in so a person never has to look for a bottle opener. Some people do not like to open twist off bottle caps with their hands because it hurts and some caps are very hard to twist off.

It is very conveinient for bottle caps that are not the twist off kind.

### THE BOTTLE CAP RECEPTACLE'S FUNCTION

The unit mounts wherever easily.

The unit holds many bottle caps.

The unit has novelty in that it has reflection effect, an obstacle bar, and lights up as the bottle cap falls to it's destination making a clanking noise. A person can easily see the bottle cap fall downwards creating a fun atmosphere.

The unit has been tested at my house over and over and the bottle cap always goes into the mouth of the unit. The lights always light up, and a person really has fun watching the bottle cap descend down the unit.

FUN FOR EVERYBODY!

Any business, private home, or just about any location would find the unit very useful and could easily address their own “logo” with stickers, paint it the way they wanted, or address the unit any manner that would fit their needs.

### DETAILED DESCRIPTION OF SEVERAL VIEWS OF THE DRAWINGS

It is a bottle cap receptacle that catches the bottle caps as they fall from a standard wall mount bottle opener.

It is forty inches in height and five inches in width at the top of the mouth all the way down to the bottom.

Where the mouth meets the stem(neck) it is two and one half inches in depth from front to back.

It is made of rigid material and has an obstacle bar that “free stands” inside the unit.

The front and sides have strong clear material that show the bottle cap as it descends down the unit.

It has sound activated lights are attached to each side of the unit that blink(flash) every time the cap strikes one of the obstacles.

The sound activated lights plug into any standard A/C wall input.

The back of the unit is reflective material that reveals the bottle cap through the strong clear material on the front and sides of the unit. Reflective material measures thirty four inches in height by four and seven/eighths inches in width.

The unit mounts easily with a hole at the top of the back of the unit on to a screw.

It is easy to remove the obstacle bar by just lifting (sliding) it out of the container. (Free stands)

The bottle caps can then be dumped into the trash.

NOTE: ALL MEASUREMENTS ARE SHOWN OF OBSTACLE BAR IN THE DRAWINGS.

The front and back obstacle bars are staggered described on pages 7,8,9, & 11 of the drawings.

The front and back obstacle bars almost are touching the front and back of the unit so the bottle cap can not go anywhere but down the unit.

The side obstacle bars are identical and keep the cap from falling out of the sides because the space between each side obstacle bar is smaller than the width of the bottle cap.

### DETAILED DESCRIPTION OF THE INVENTION OF THE FRAME(CONTAINER)

The sound activated lighted bottle cap receptacle is described as follows:

FRAME:

The actual frame is constructed out of strong material that will allow for normal wear and tear on the unit. The width of the strong material is one/eight of an inch in thickness.

1. The unit measures from top to bottom at forty inches.

2. The unit measures at very top from the mouth to the back at five inches.

3. The unit measures from mouth to stem(angle of the front) at five inches.

4. The unit measures from where the mouth meets stem from front to back at two and one/half inches all the way to the bottom giving the frame a slim look for easy usefulness.

5. The unit measures from stem to bottom at thirty-five inches.

6. From side to side the unit is five inches all the way from the top to the bottom.

7. The back has a centered hole one inch down from top of the back for mounting the unit.

8. The back has a reflective material that measures four and seven/eight's in width by thirty four inches in length.

9. The right or left side has a hole for the wiring traveling to the A/C wall receptacle. This unit has the hole for wiring on the left but could be done on either side depending on the where mounted.

10. The sound activated lights are attached to the unit on this model on the sides. The lights that I used are twenty one inches in height and one inch in width both ways.

NOTE: Any sound activated lights may be used but I just happened to use the ones I mentioned.

11. The wiring is about twelve feet in length and attached to my kitchen using staples traveling under the cabinets so the wiring is not visible. Any length of wiring could be used.

### DETAILED DESCRIPTION OF OBSTACLE BAR

The method of the construction of the obstacle bar is described on pages 7,8, and 9 of the drawing in the plastic package.

### EXPLANATION AS FOLLOWS: NOTE: (THIS PAGE EXPLAINS SPACE ALLOWED BETWEEN OBSTACLES.)

1. The front side obstacle bar is spaced in measurement center to center every one and one/half inches from the top of the obstacle bar to the bottom of the obstacle bar.

2. The back side obstacle bar is spaced in measurement center to center every one and one/half inches from the top of the obstacle bar to the bottom of the obstacle bar.

3. The back obstacle bar starts with the first bar being at the very top of the obstacle bar creating a back guide for the bottle cap to be forced into the obstacle bar. It is necessary for the back bar to start at the very top to guide the bottle cap into the obstacle bar.

4. The front obstacle bar starts one/ half inch down from the very top of the obstacle bar and faces the opposite of the back obstacle bar to create the “staggering” effect for the bottle cap to descend. The construction forces the bottle cap to descend string each front and back obstacle bars as it descends.

5. The side bars start one quarter of an inch from the top and are identical in measurement. From center to center they measure one and one/ eighth inches all the way to the bottom of the obstacle bar. The side bars prevent the bottle cap from falling out of the obstacle bar sides because the sides measurement is a one inch opening NOTE: ALL BOTTLE CAPS THAT I HAVE MEASURED ARE ONE AND ONE/EIGHT INCHES WIDE. THUS, THE BOTTLE CAP CAN NOT ESCAPE THE SIDES BECAUSE THE BOTTLE CAP IS WIDER THAN THE SIDE BAR OPENING.

NOTE: (THIS PAGE GIVES THE ACTUAL MEASUREMENT OF THE OBSTACLE BARS)

1. The obstacle bar measures from top to bottom at thirty four inches leaving room for the (guides illustrated in drawings). The guides are attached to the frame for smooth operation.

2. The obstacle bar is constructed from a strong material. The strong material used for support on all four sides (round rods that are vertical) measure three/eight's of an inch in width from top to bottom.

3. The strong material used for the obstacle (round rods that are horizontal) measure three/ sixteenth's in diameter.

4. The strong material three/eight's inch round rods that are vertical are drilled with holes a bit smaller than the three/sixteenth's horizontal obstacle so the three/ sixteenth's inch horizontal rods fit secure into the round vertical rods. This makes the obstacle bar very stable.

5. The strong material used for the horizontal ladder (where the bottle cap strikes) measures one inch and three/quarters in width for each obstacle. Exterior to exterior horizontally.

6. WHEN THE OBSTACLE BAR IS ATTACHED TOGETHER IT CREATES A OPEN SQUARE SPACE FROM TOP TO BOTTOM THAT MEASURES ONE AND THREE/SIXTEENTH'S INCHES OF SPACE (LIKE AND OPEN SQUARE BOX.)

SINCE THE BOTTLE CAPS ARE ONE AND ONE/EIGHT INCH IN WIDTH THE BOTTLE CAPS ARE FORCED TO STRIKE THE OBSTACLE BAR THERE IS ONLY ONE/THIRTY SECOND INCH OF OPEN SPACE ON EACH SIDE BETWEEN THE BOTTLE CAP AND THE INSIDE OF THE OBSTACLE BAR.

CLAIM OF INVENTION: PAGE 1

What I claim as my invention is a sound activated lighted bottle cap receptacle with an obstacle bar and reflective material:

1. All of the materials that were used to create my invention were purchased by my self.
The idea and time spent on the unit are my own with help from no one.
The products used to construct my invention have been invented before, but the manner in which I used the materials gave me the aid in the creation of my invention.
I claim that all of the construction was done by my self.
In the manner of the way the unit functions, all of the materials that were used are necessary for completion of the invention.
I have searched and found no other sound activated, lighted, bottle cap receptacle with an obstacle bar and reflective material.
I claim my invention is a first and seek protection on the concept, construction, function, and the manner in which the following three listed numbered items operate the unit. I also address that these three listed items can be in different mathematical measurements. I am seeking protection that the unit may be constructed with these items in many different configurations.
LIST AS FOLLOWS:
1. THE FRAME OF THE UNIT(CONTAINER)./ANY STRONG MATERIAL MAY BE USED.
The way the frame(container) functions as stated previously that this frame is different than any other.
2. THE OBSTACLE BAR/ANY STRONG MATERIAL MAY BE USED.
The way the obstacle bar functions there has been none ever used before for a bottle cap receptacle.
3. THE GUIDES/ANY STRONG MATERIAL MAY BE USED.
The way the guides work to force the bottle cap to descend into the frame(container).
CLAIM OF INVENTION:PAGE 2
The following three items listed below were also used to aid in construction of the invention. I seek protection only on the manner in which they were used to complete my invention and not the actual three items listed below.
LIST AS FOLLOWS:
1. THE REFLECTIVE MATERIAL
Any reflective material may be used for its' function of the invention.
2. THE SOUND ACTIVATED LIGHTS
Any sound activated lights may be used for its' function of the invention.
3. THE ELECTRICAL WIRING
Any standard wiring may be used for its' function of the invention.
All of the items mentioned in both lists on page 1 & 2 of the claim of the invention collectively make the invention operate in the way that I constructed the invention.
My honest thoughts and beliefs on this invention are that is a utility that could be used anywhere aiding in making the bottle cap go into a container rather than being of the floor, table top, or anywhere that would make the removal of the bottle cap twice as much work. In addition, the way the invention operates creates novelty every time it is used by a person(s).
I am seeking a utility patent for this invention.
Thank you for your cooperation in reading all of the material enclosed in the plastic pouch.
